(19) United States
(12) Patent Application Publication
(10) Pub. No.: US 2021/0350432 A1
(43) Pub. Date: Nov. 11, 2021

(54) SYSTEMS AND METHODS FOR AUTOMATICALLY DIGITIZING CATALOGS

(71) Applicant: Aleran Software, Inc., Minneapolis, MN (US)

(72) Inventor: Alexander Simon Kushner, Plymouth, MN (US)

(21) Appl. No.: 17/314,947

(22) Filed: May 7, 2021

Related U.S. Application Data
(60) Provisional application No. 63/022,106, filed on May 8, 2020.

(51) Int. Cl. G06Q 30/06; G06N 20/00; G06F 9/451; G06K 9/00

(52) U.S. Cl. CPC G06Q 30/0603; G06Q 30/0643; G06F 40/134; G06F 9/451; G06K 9/00442; G06N 20/00

(57) ABSTRACT

The present disclosure provides systems, methods, and computer program products for generating a digital map of a catalog. An example method may comprise (a) obtaining (i) an electronic version of the catalog and (ii) a products list comprising data corresponding to a plurality of products; (b) processing the electronic version of the catalog with an algorithm to identify one or more items in the electronic version of the catalog; (c) associating an item in the electronic version of the catalog with a product in the products list; (d) based at least in part on the processing in (b) and the associating in (c), generating the digital map of the catalog, wherein the digital map comprises data about the item in the catalog; and (e) using the digital map, generating an interactive graphical element associated with the item in the catalog.

### CROSS-REFERENCE

This application claims priority to U.S. Provisional Application No. 63/022,106, filed on May 8, 2020, which is hereby incorporated by reference herein in its entirety.

### BACKGROUND

Catalogs may be at the heart of merchandising for many manufacturers, whether such manufactures conduct business-to-business (“B2B”) or business-to-customer (“B2C”) transactions. Companies may dedicate significant resources to creating catalogs that reflect their product offerings, and they may carefully design catalogs to have a particular look and feel that draws customers in and maintains their interest. However, a customer (e.g., an online shopper) may need to leave the catalog environment to actually purchase a product depicted in the catalog. For example, the customer may need to type a stock keeping unit (“SKU”) number into a web-based form to find more detailed information about the product or buy the product. This may result in an interruption in the customer's experience as his attention is taken away from the mood that was carefully crafted in the catalog and shifted to a webpage or an online application that may not have the same mood. This interruption, which may be referred to as “sales breakage” in this disclosure, may be a frustrating experience that results in the loss of enthusiasm for a product, and consequently, a loss in revenue.

### SUMMARY

The present disclosure provides systems and methods for hot-spotting digital catalogs using artificial intelligence. A system described herein can hotspot a catalog by identifying items in the catalog using various types of artificial intelligence (e.g., optical character recognition, image recognition, etc.) and associating those items with database entries corresponding to products. Thereafter, the system can generate a digital map of the catalog. The digital map may include information about each item in the catalog, including the item's SKU and product code, a description of the item, geometric coordinates of text and images in the catalog that are associated with the item, and links to images of the item. The digital map may additionally include a link to a sales webpage for the item. The system can insert the link into the catalog as a hotspot. In some cases, the system may use the digital map to generate an interactive sales tool from scratch. The interactive sales tool may be a sales webpage. The sales webpage may include shopping cart and payment functionality. The interactive sales tool may be accessible through the catalog, e.g., through hyperlinks to the sales webpage or via embedded hotspots in the catalog.

The system described above can reduce the amount of time required to hotspot a catalog. Existing hot-spotting methods may require a person to manually scan through each page of a catalog, identify SKUs through a boxing function, and associate the boxes with products in a product database. This manual process is laborious, error-prone, and time-consuming. The systems and methods described herein may improve upon this manual hot-spotting process.

In one aspect, the present disclosure provides a method for generating a digital map of a catalog, comprising: (a) obtaining (i) an electronic version of the catalog and (ii) a products list comprising data corresponding to a plurality of products; (b) processing the electronic version of the catalog with an algorithm to identify one or more items in the electronic version of the catalog; (c) associating an item of the one or more items in the electronic version of the catalog with a product of the plurality of products in the products list; (d) based at least in part on the processing in (b) and the associating in (c), generating the digital map of the catalog, wherein the digital map comprises data about the item in the catalog; and (e) using the digital map, generating an interactive graphical element associated with the item in the catalog, wherein the interactive graphical element is configured to permit the user to purchase the product associated with the item.

In some embodiments, the interactive graphical element comprises a hyperlink to a sales webpage for the product. In some embodiments, the interactive graphical element is an embedded hotspot. In some embodiments, (b) comprises processing a plurality of identification codes associated with the one or more items that appear in the electronic version of the catalog. In some embodiments, the plurality of identification codes comprises stock-keeping units. In some embodiments, (b) comprises processing a plurality of images of the one or more items that appear in the electronic version of the catalog. In some embodiments, (b) comprises processing a plurality of descriptions of the one or more items that appear in the electronic version of the catalog. In some embodiments, the algorithm is a machine learning algorithm. In some embodiments, the machine learning algorithm comprises an optical character recognition algorithm and an image processing algorithm. In some embodiments, the machine learning algorithm has been trained on a labeled set of images of products. In some embodiments, the method further comprises generating an interactive visualization of the digital map, wherein the interactive visualization is configured to be edited by a user. In some embodiments, the data in the digital map comprises a stock keeping unit, universal product code, description, price, catalog geometric coordinates, and hyperlinks associated with the item. In some embodiments, the method further comprises using the digital map to generate an electronic commerce website comprising shopping cart functionality and payment integration.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates a system that can automatically digitize, or “hotspot,” a catalog, according to some embodiments of the present disclosure;

FIG. 2 is a flow chart of a process for generating a digital map of a catalog, according to some embodiments of the present disclosure; and

FIG. 3 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “hotspot” as used herein generally refers to an interactive element in a digitized catalog (e.g. a Portable Document Format (“PDF”) catalog) that may show additional information about a product (e.g. description, price, extra images, etc.) or provide shopping cart or payment functionality that enables a user to buy the product. Hotspots may be embedded hotspots, or they may be links to separate webpages.

The term “hot-spotting” as used herein generally refers to the process by which a hotspot is added to a catalog.

The term “digital map” as used herein generally refers to data corresponding to items depicted in a catalog. The data may include an item's stock keeping unit (“SKU”) and product code, a name of the item a description of the item, a price of the item, geometric coordinates of text and images in the catalog that are associated with the item, links to images of the item, links to a sales webpage for the item, and the like.

Catalogs may serve as an interface between a manufacturer or retailer and a customer. The look and feel of retail catalogs may be optimized for pleasurable and coherent customer viewing. However, graphic designers may not consider online customers when designing such retail catalogs. Retailers may provide digital copies of their catalogs online, but the digital copies may not have integrated sales and payment functionality. Retailers may manually insert “hotspots” into their digital catalogs to enable such functionality, but manual hot-spotting may involve cross-referencing each item in the catalog with a products list, which may be a time-consuming and arduous process. Additionally, such manual hot-spotting may be inherently prone to human errors.

In an aspect, the present disclosure provides a computer-implemented method for generating a digital map of a catalog. The method may comprise obtaining (i) an electronic version of the catalog and (ii) a products list comprising data corresponding to a plurality of products. The method may further comprise processing the electronic version of the catalog to identify one or more items in the electronic version of the catalog. The processing may involve the use of artificial intelligence or machine learning (e.g., optical character recognition, image recognition, etc.). The method may further comprise associating an item in the plurality of items with a product of the plurality of products in the product list. The association may be a two-way association. The method may further comprise generating a digital map of the catalog based at least in part on the processing and the associating. The digital map may include data about the associated items and products. For each item-product pair, the data may comprise an SKU, a universal product code (“UPC”), a product description and other text about the product, geometric coordinates that define the arrangement of images and text associated with the item in the catalog, links to catalog images, links to product webpages, and the like. The method may further comprise using the digital map to generate an interactive graphical element associated with the item in the catalog. The interactive graphical element may comprise a hyperlink to a sales webpage for the product. The interactive graphical element may additionally or alternatively permit a customer to purchase the product associated with the item directly from the catalog. The interactive graphical element may be an embedded hotspot. The hotspot may allow the customer to access the information about the associated item and product. For example, the customer may interact with the hotspot to see additional information associated with an item in the catalog. The customer may interact with the hotspot, for example, by hovering or clicking over an image, text, or other digital elements on the catalog. The interaction can activate the hotspot to create a digital geometrical frame that may contain the information associated with the item in the catalog.

In some cases, the system may use the digital map to generate an interactive sales tool from scratch. The interactive sales tool may be a sales webpage for the items in the catalog. The sales page may include shopping cart and payment functionality. The interactive sales tool may be accessible through the catalog, e.g., through hyperlinks to the sales webpage or via embedded hotspots in the catalog.

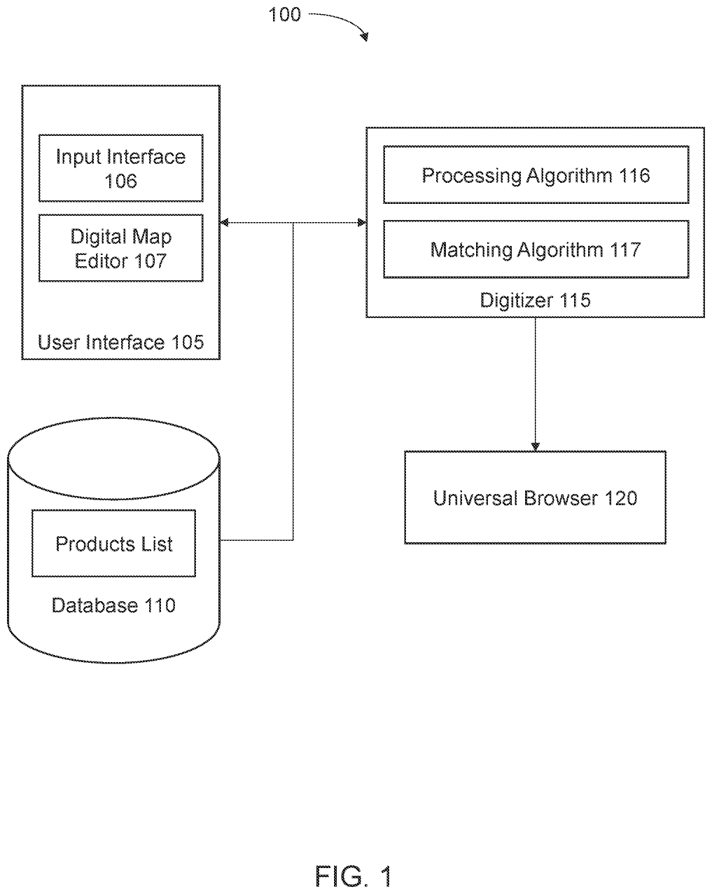

FIG. 1 schematically illustrates a system 100 that can automatically digitize, or “hotspot,” a catalog. The catalog may be an e-commerce, manufacturing, distribution, wholesale, or vendor catalog. The catalog may be a retail catalog. The catalog may include items such as apparel, footwear, sporting goods, kitchen accessories, auto parts, home furnishings, lawn and garden items, health, beauty and food items. The catalog may include products from a plurality of retailers or manufacturers. The catalog may be digital. The digital catalog may be in PDF, PNG, or JPG format, or the like. In some cases, the digital catalog may not include sales or payment integration, may not include additional information about a product beyond an image or a product code (e.g. UPC, or SKU), or may not otherwise be optimized for ecommerce. In some cases, the catalog may include a plurality of products in a single image. The item on the catalog may be ambiguous. The automatic hot-spotting process, schematically shown in FIG. 1 may augment an existing digital catalog with additional information and interactive graphical elements. The additional information and interactive graphical elements can improve the digital catalog.

The system 100 may have a user interface 105, a database 110, a digitizer 115, and a universal browser 120. The user interface (UI) 105 may have an input interface 106 and a digital map editor 107. A user can provide user input or feedback in the user interface 105 to interact with the system 100. The input interface 106 may enable the user to provide an electronic version of the catalog and a products list to the system 100.

The digital map editor 107 may enable the user to edit the digital map manually. The digital map editor 107 may comprise an interactive visualization of the digital map. The UI 105, the input interface 106, and/or the digital map editor 107 may comprise a graphical user interface (GUI). The UI 105, the input interface 106, and/or the digital map editor 107 may further comprise one or more input devices (e.g., touchscreen, mouse, keyboard, and the like).

The database 110 may comprise one or more memory devices configured to store data. The database 110 may be utilized for storing information associated with products in product lists. The database 110 may be used to store SKUs, UPCs, product descriptions (e.g. price, dimensions, color, physical properties of the product, chemical properties of the product, number of units remaining, number of units sold, etc.), packaging and delivery information, links to webpages associated with a product (e.g. online store for a product, recent news articles, relevant social media posts, etc.).

The database 110 may comprise local databases, and/or cloud databases. The database 110 may utilize any suitable database techniques (e.g. query language (SQL) or “NoSQL”). The database 110 may further comprise a plurality of databases. Some of the databases in the database 110 may be implemented using various standard data structures, such as an array, hash, (linked) list, struct, structured text file (e.g., XML), table, JavaScript Object Notation (JSON), NOSQL and/or the like. Such data structures may be stored in memory and/or in (structured) files. The database 110 may comprise object-oriented databases. Object databases can include a number of object collections that are grouped and/or linked together by common attributes; they may be related to other object collections by some common attributes. Object-oriented databases may perform similarly to relational databases with the exception that objects are not just pieces of data but may have other types of functionality encapsulated within a given object. The database 110 may include a graph database that uses graph structures for semantic queries with nodes, edges and properties to represent and store data. Also, the database 110 may be implemented as a mix of data structures, objects, and relational structures. Databases may be consolidated and/or distributed in variations through standard data processing techniques. Portions of databases, e.g., tables, may be exported and/or imported and thus decentralized and/or integrated.

The digitizer 115 can generate a digital map of the catalog. The digitizer 115 may have a processing algorithm 116 and a matching algorithm 117. The processing algorithm 116 can process a digital version of the catalog to identify items or features of items in the catalog. The processing algorithm 116 may be or include an image processing algorithm or an optical character recognition (“OCR”) algorithm.

The image processing algorithm may be a computer vision algorithm. The image processing algorithm can process images of products in the catalog. In some cases, the image processing algorithm may be a classifier that classifies images within the catalog as depicting particular products. The classifier may be a supervised machine learning algorithm trained on a labeled set of training images or a large number of catalogs. The set of training images may include multiple images (e.g., from various angles) of all of the company's product offerings. Each image may be associated with a label that identifies the product that the image shows. The label may be a unique identifier of the product. In other cases, the image processing algorithm may be a feature extraction algorithm. The feature extraction algorithm may extract features (e.g., product dimensions, colors, descriptions (e.g., “shirt” or “pants”), etc.) from an image in a catalog that can later be consumed by the matching algorithm 117. For example, the matching algorithm 117 can compare the extracted features to descriptions in the products list. The image processing algorithm may be a geometry-based algorithm or a statistics-based algorithm (e.g., a trained machine learning algorithm).

The image processing algorithm can also extract geometric coordinates from images in the catalog. The geometric coordinates may define how images and text are arranged on the pages of the catalog. The system 100 can use the geometric coordinates to reproduce the layout of the catalog on sales page, for example.

The OCR algorithm may be an image processing algorithm trained to identify text in the catalog. The OCR algorithm can scan the pages of the catalog and identify SKUs and other product numbers, product names, product descriptions, and the like.

The algorithms described above may be supervised machine learning (ML) algorithms. A supervised ML algorithm can be trained using labeled training inputs, i.e., training inputs with known outputs. The training inputs can be provided to an untrained or partially trained version of the ML algorithm to generate a predicted output. The predicted output can be compared to the known output, and if there is a difference, the parameters of the ML algorithm can be updated. A semi-supervised ML algorithm can be trained using a large number of unlabeled training inputs and a small number of labeled training inputs.

The algorithms described herein may be neural networks. Neural networks may employ multiple layers of operations to predict one or more outputs, e.g., the identity of a pictured product. Neural networks can include one or more hidden layers situated between an input layer and an output layer. The output of each layer can be used as input to another layer, e.g., the next hidden layer or the output layer. Each layer of a neural network can specify one or more transformation operations to be performed on input to the layer. Such transformation operations may be referred to as neurons. The output of a particular neuron can be a weighted sum of the inputs to the neuron, adjusted with a bias and multiplied by an activation function, e.g., a rectified linear unit (ReLU) or a sigmoid function.

Training a neural network can involve providing inputs to the untrained neural network to generate predicted outputs, comparing the predicted outputs to expected outputs, and updating the algorithm's weights and biases to account for the difference between the predicted outputs and the expected outputs. Specifically, a cost function can be used to calculate a difference between the predicted outputs and the expected outputs. By computing the derivative of the cost function with respect to the weights and biases of the network, the weights and biases can be iteratively adjusted over multiple cycles to minimize the cost function. Training may be complete when the predicted outputs satisfy a convergence condition, e.g., a small magnitude of calculated cost as determined by the cost function.

One type of neural network is a convolutional neural network (“CNN”). CNNs are neural networks in which neurons in some layers, called convolutional layers, receive pixels from only small portions of the input data set. These small portions may be referred to as the neurons' receptive fields. Each neuron in such a convolutional layer may have the same weights. In this way, the convolutional layer can detect features in any portion of the input data set. CNNSs may also have pooling layers that combine the outputs of neuron clusters in convolutional layers and fully-connected layers that are similar to traditional layers in a feed-forward neural network. CNNs may be particularly good at detecting and classifying object (e.g., products) in images.

The matching algorithm 117 can match items identified in the catalog with products in the products list. The matching algorithm 117 can do so by comparing data from the products list with features of items identified by the processing algorithm 116. The matching algorithm 117 may be or include a search algorithm. The search algorithm may scan the products list for features identified by the processing algorithm 116. The search algorithm may find one or more partial or complete matches. The search algorithm may determine that a particular item from the catalog matches a product from the products list if a threshold number or proportion of features match.

In some cases, the processing algorithm 116 may directly classify an item as a product, e.g., by outputting a unique identifier of the product. In such cases, the matching algorithm 117 can perform a simple query of the products list for that unique identifier. In other cases, the processing algorithm 116 may only extract certain features or descriptors of items from the catalog rather than directly classifying items as products. In such cases, the matching algorithm 117 can match the features or descriptors to corresponding features or descriptors in the products list using the process described above.

After the matching algorithm 117 associates each item in the catalog with a product in the products list, the digitizer 115 can generate the digital map of the catalog. For each item in the catalog, the digital map may comprise data about the item from the products list (e.g., SKU and product code, name, description, dimensions, price, link to image, link to sales page, etc.) and information extracted from the catalog (e.g., geometric coordinates). The digital map can be used to reproduce the catalog in the form of an e-commerce website, for example. The e-commerce website may substantially replicate the look and feel or layout or the catalog to ensure a consistent user experience. The digital map can also be used to generate and insert hotspots into the catalog. Such hotspot may be links or embedded hotspots.

The universal browser 120 may show the digitized catalog including the hotspots and hyperlinks. The digitized catalog (e.g. hot-spotted catalog) may be shown on the universal browser using a plurality of formats such as PDF, HTML, CSS, etc. The universal browser may also show the PDF digitized catalog in a flip-book manner with clickable discovered hot-spots. The universal browser 120 can be used on any website, business application, mobile device, etc. The universal browser may comprise computer code produced using one or more computer languages such as HTML, JavaScript, or CSS. The universal browser 120 may use one or more software techniques such as Universal Windows Platform (UWP), or WebView Control.

The components of FIG. 1 (e.g., the digitizer 115) and may be implemented on one or more computing devices. The computing devices may be servers, desktop or laptop computers, electronic tablets, mobile devices, or the like. The computing devices may be located in one or more locations. The computing devices may have general-purpose processors, graphics processing units (GPU), application-specific integrated circuits (ASIC), field-programmable gate-arrays (FPGA), or the like. The computing devices can additionally have memory, e.g., dynamic or static random-access memory, read-only memory, flash memory, hard drives, or the like. The memory can be configured to store instructions that, upon execution, cause the computing devices to implement the functionality of the subsystems. The computing devices can additionally have network communication devices. The network communication devices can enable the computing devices to communicate with each other and with any number of user devices, over a network. The network can be a wired or wireless network. For example, the network can be a fiber optic network, Ethernet® network, a satellite network, a cellular network, a Wi-Fi® network, a Bluetooth® network, or the like. In other implementations, the computing devices can be several distributed computing devices that are accessible through the Internet. Such computing devices may be considered cloud computing devices.

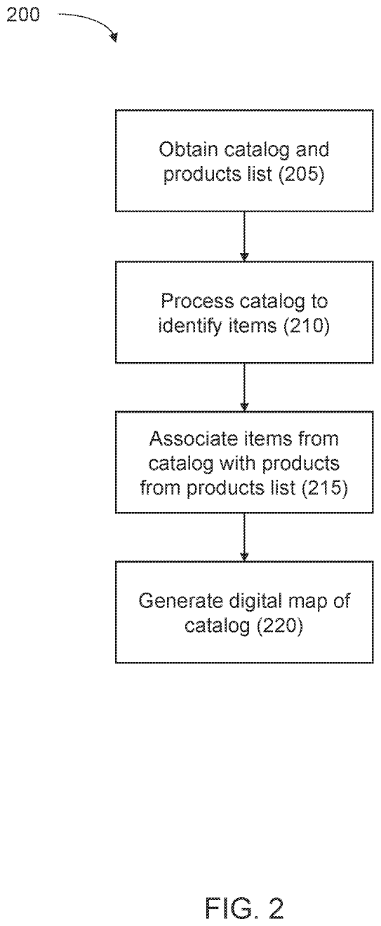

FIG. 2 is a flow chart of an example process 200 for generating a digital map of a catalog. The process 200 can be performed by a system of one or more computers in one or more locations. For example, the system 100 can perform the process 200.

The system can obtain a catalog and a products list (205). The catalog and the products list may be provided by a user (e.g., manufacturer, retailer) through the user interface 105. The catalog may or may not be machine-readable. In some cases, portions of the catalog may be machine-readable, but others may not. The catalog may be provided in a digital format such as PDF, PNG, JPG, Hypertext Markup Language (HTML), JavaScript, Cascading Style Sheets (CSS), or the like. The catalog may not include any hotspots or links (e.g., dynamic links, or hyperlinks, etc.). The catalog may not be optimized for selling products.

The products list may include a list of products and data about the products (e.g., identification number, name, description, dimensions, price, images, hyperlinks, etc.). The products list may be organized in a table format. The products list may be stored in a database accessible using a database language such as a data manipulation language (DML), data control language (DCL), data definition language (DDL), or may be in a relational database format such as SQL, Java Database Connectivity (JDBC), Amazon Aurora, MySQL, etc. In some cases, operation 205 may comprise obtaining a plurality of catalogs or a plurality of products list.

The system can process the catalog to identify items in the catalog (210). The system can use one or more algorithms to process the catalog. The one or more algorithms may include an OCR algorithm and an image processing algorithm. The image processing algorithm may be a supervised machine learning algorithm. In some cases, the image processing algorithm may be trained to classify images of items in the catalog as particular products. In other cases, the image processing algorithm may be trained to extract features from the images. Such features may be used in a subsequent operation. The image processing algorithm can also extract geometric coordinates from images of items in the catalog. The geometric coordinates may define how images and text are arranged on the pages of the catalog.

The OCR algorithm can identify text in the catalog, including product codes, names, descriptions, and the like.

The system can associate items from the catalog with products from products list (215). If in operation 210 the algorithm classified an item as a product, e.g., by outputting the unique identification code of the product, associating the item with the product may involve a simple query of the products list for the unique identification code. If, on the other hand, the algorithm in operation 210 extracted features from items in the catalog, associating an item with a product may involve matching extracted features with data in the products list. The output of operation 215 may be item-product pairs.

Based on the processing in operation 210 and the associating in operation 215, the system can generate a digital map of the catalog (220). The digital map may include data extracted from the digital catalog in operation 210 and data from the products list. For example, the data may include, for each item-product pair an SKU, a UPC, sales data (e.g. price, availability in stock or at a location, number of units sold), product description, text/image geometric coordinates within the catalog, a link to the item in the digital catalog, a link to the product in an online store, or the like. Operation 215 may further comprise generating an interactive visualization of the digital map. The interactive visualization may allow a user to modify the digital map by adding, changing, editing, or removing data. This may include a change in the products data, a link to the online store, additional links to help a seller or the customer. The editing may be due to an improvement in the product.

### Computer Systems

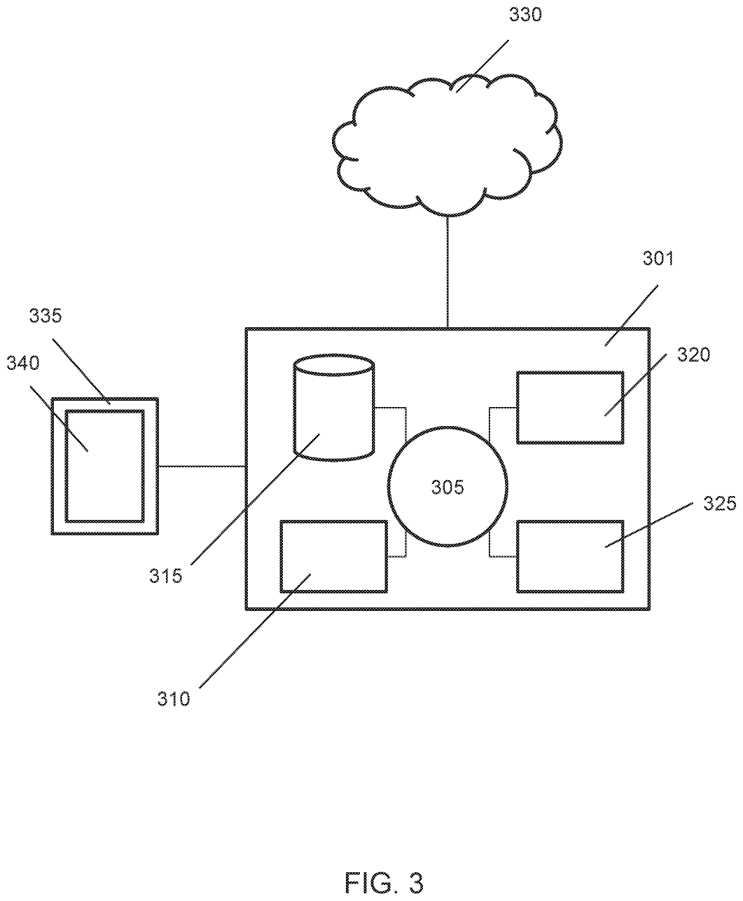

The present disclosure provides computer systems that are programmed to implement methods of the disclosure. FIG. 3 shows a computer system 301 that is programmed or otherwise configured to communicate with one or more storage or memory devices. The computer system 301 can regulate various aspects of the present disclosure, such as, for example, hot-spotting a digital catalog, associating items in a catalog to products in product lists, generating a digital map of the catalog, associating dynamic and/or hyper-links to an item, and allowing a user to purchase an item. The computer system 301 can be an electronic device of a user or a computer system that is remotely located with respect to the electronic device. The electronic device can be a mobile electronic device.

The computer system 301 includes a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage and/or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet and/or extranet, or an intranet and/or extranet that is in communication with the Internet. The network 330 in some cases is a telecommunication and/or data network. The network 330 can include one or more computer servers, which can enable distributed computing, such as cloud computing. The network 330, in some cases with the aid of the computer system 301, can implement a peer-to-peer network, which may enable devices coupled to the computer system 301 to behave as a client or a server.

The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback.

The CPU 305 can be part of a circuit, such as an integrated circuit. One or more other components of the system 301 can be included in the circuit. In some cases, the circuit is an application specific integrated circuit (ASIC).

The storage unit 315 can store files, such as drivers, libraries and saved programs. The storage unit 315 can store user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user (e.g., customer, client, or merchant). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 330.

Methods as described herein can be implemented by way of machine (e.g., computer processor) executable code stored on an electronic storage location of the computer system 301, such as, for example, on the memory 310 or electronic storage unit 315. The machine executable or machine-readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 301 can include or be in communication with an electronic display 335 that comprises a user interface (UI) 340 for providing, for example, a user interface that permits a user to upload a products list and a digital version of a catalog. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305. The algorithm can, for example, obtain an electronic version of a catalog and a products list, process the electronic version of the catalog to identify one or more items in the catalog, associate an item from the one or more identified items to a product from the product list, generate a digital map of the catalog based at least in part on the associated item and product, and use the digital map to generate a hotspot.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for generating a digital map of a catalog, comprising:
(a) obtaining (i) an electronic version of said catalog and (ii) a products list comprising data corresponding to a plurality of products;
(b) processing said electronic version of said catalog with an algorithm to identify one or more items in said electronic version of said catalog;
(c) associating an item of said one or more items in said electronic version of said catalog with a product of said plurality of products in said products list;
(d) based at least in part on said processing in (b) and said associating in (c), generating said digital map of said catalog, wherein said digital map comprises data about said item in said catalog; and
(e) using said digital map, generating an interactive graphical element associated with said item in said catalog, wherein said interactive graphical element is configured to permit said user to purchase said product associated with said item.

2. The method of claim 1, wherein said interactive graphical element comprises a hyperlink to a sales webpage for said product.

3. The method of claim 1, wherein said interactive graphical element is an embedded hotspot.

4. The method of claim 1, wherein (b) comprises processing a plurality of identification codes associated with said one or more items that appear in said electronic version of said catalog.

5. The method of claim 4, wherein said plurality of identification codes comprise stock-keeping units.

6. The method of claim 1, wherein (b) comprises processing a plurality of images of said one or more items that appear in said electronic version of said catalog.

7. The method of claim 1, wherein (b) comprises processing a plurality of descriptions of said one or more items that appear in said electronic version of said catalog.

8. The method of claim 1, wherein said algorithm is a machine learning algorithm.

9. The method of claim 8, wherein said machine learning algorithm comprises an optical character recognition algorithm and an image processing algorithm.

10. The method of claim 8, wherein said machine learning algorithm has been trained on a labeled set of images of products.

11. The method of claim 1, further comprising generating an interactive visualization of said digital map, wherein said interactive visualization is configured to be edited by a user.

12. The method of claim 1, wherein said data in said digital map comprises a stock keeping unit, universal product code, description, price, catalog geometric coordinates, and hyperlinks associated with said item.

13. The method of claim 1, further comprising, using said digital map to generate an electronic commerce website comprising shopping cart functionality and payment integration.

14. The method of claim 13, wherein the electronic commerce website substantially replicates the look and feel or layout of said catalog.

15. One or more non-transitory computer-readable storage media storing instructions that are operable, when executed by one or more computers, to cause the one or more computers to perform operations comprising:
obtaining (i) an electronic version of a catalog and (ii) a products list comprising data corresponding to a plurality of products;
processing said electronic version of said catalog with an algorithm to identify one or more items in said electronic version of said catalog;
associating an item of said one or more items in said electronic version of said catalog with a product of said plurality of products in said products list;
based at least in part on said processing in (b) and said associating in (c), generating a digital map of said catalog, wherein said digital map comprises data about said item in said catalog; and
using said digital map, generating an interactive graphical element associated with said item in said catalog, wherein said interactive graphical element is configured to permit said user to purchase said product associated with said item.

16. A system comprising:
a database configured to store a products list comprising data corresponding to a plurality of products; and
one or more computer processors operatively coupled to said database, wherein said one or more computer processors are individually or collectively programmed to perform operations comprising:
obtaining an electronic version of a catalog;
processing said electronic version of said catalog with an algorithm to identify one or more items in said electronic version of said catalog;
associating an item of said one or more items in said electronic version of said catalog with a product of said plurality of products in said products list;
based at least in part on said processing in (b) and said associating in (c), generating a digital map of said catalog, wherein said digital map comprises data about said item in said catalog; and
using said digital map, generating an interactive graphical element associated with said item in said catalog, wherein said interactive graphical element is configured to permit said user to purchase said product associated with said item.

17. The system of claim 16, wherein said interactive graphical element comprises a hyperlink to a sales webpage for said product.

18. The system of claim 16, wherein said interactive graphical element is an embedded hotspot.
